(19) United States
(12) Patent Application Publication
(10) Pub. No.: US 2020/0275539 A1
(43) Pub. Date: Aug. 27, 2020

(54) CONSTANT CURRENT DIMMING APPARATUS FOR LED LAMP

(71) Applicant: ADPOWER Technology (WuXi) Co., Ltd., Wuxi (CN)

(72) Inventors: Shijie Wang, Wuxi (CN); Sen Hu, Wuxi (CN); Ruopeng Xu, Wuxi (CN)

(21) Appl. No.: 16/796,868

(22) Filed: Feb. 20, 2020

(30) Foreign Application Priority Data
Feb. 22, 2019 (CN) 201910133012.4

(51) Int. Cl. H05B 45/335; H05B 45/345; H05B 45/10; H05B 45/325

(52) U.S. Cl. CPC H05B 45/335; H05B 45/325; H05B 45/10; H05B 45/345

(57) ABSTRACT

A constant current dimming apparatus for an LED lamp includes a signal generator and a power converter, where an input end of the signal generator is externally connected to a dimming device; an output end of the signal generator is connected to the power converter; an input end of the power converter is connected to an input voltage; and an output end of the power converter is connected to a positive electrode end and a negative electrode end of the LED lamp. The signal generator is used for transmitting a variable frequency pulse signal to the power converter upon receipt of a dimming signal of the dimming device. According to the present invention, a wide dimming range is achieved, and a dimming depth can reach 1‰ of a rated voltage or rated current.

### CROSS-REFERENCE TO PRIOR APPLICATION

This application claims the benefit of Chinese Patent Application No. 201910133012.4 filed on Feb. 22, 2019, the contents of which are incorporated herein by reference.

### TECHNICAL FIELD

The present invention relates to the field of LED illumination, and in particular, to a constant current dimming apparatus for an LED lamp, for achieving deep dimming.

### BACKGROUND ART

At present, dimming solutions applied to a LED driving power source are implemented mainly in the following methods: The first method is analog dimming, that is, an output current or voltage continuously changes with an analog dimming signal. This method has the advantages that there is no flicker in the dimming process and after the dimming is stable, but the dimming method is easily disturbed during the dimming and a dimming range is narrow and is generally 5%-100%, and flicker occurs easily when the dimming range is less than 5%. The second method is pulse width modulation (PWM) dimming, that is, a power conversion module is controlled by using a pulse width modulated pulse signal such that an output current or voltage is changed with the PWM signal. Although the anti-interference capability is strong and the dimming range is wide, the dimming method has a small number of pulses output by a DC/DC controller during enabling time of the dimming signal in the case of a small duty ratio; in the dimming process, the output current exhibits a stepped change with the change of the number of the pulses, which leads to the flicker in the dimming process, and if the operating frequency of the power conversion module is increased, the device loss will be excessive. The third method is PWM+analog hybrid dimming, that is, PWM+analog dimming is used when the brightness is relative low, and analog dimming is used when the brightness is relative high. The dimming depth is wide and a dimming range of 1%-100% generally can be achieved, but flicker may still occur when the dimming depth is very small.

Therefore, the above dimming solutions cannot achieve a very low dimming depth, and the disadvantages are more obvious especially when a lower operating frequency is applied under some large power requirements. There is an urgent need to find a new technical solution to solve the above problems.

### SUMMARY OF THE INVENTION

The technical problem to be solved by the present invention is to overcome the defects in the prior art, and we provide a constant current dimming apparatus for an LED lamp, which achieves a wide dimming range, enables a dimming depth to be below 1‰, and makes the LED lamp free of flicker during the dimming process and after the dimming is stable. The present invention solves the above technical problems by the following technical solutions:

The present invention provides a dimming and driving apparatus for an LED lamp, where the dimming and driving apparatus for the LED lamp includes a signal generator and a power converter, where an input end of the signal generator is externally connected to a dimming device; an output end of the signal generator is connected to the power converter; an input end of the power converter is connected to an input voltage; an output end of the power converter is connected to a positive electrode end and a negative electrode end of the LED lamp; the signal generator is used for transmitting a variable frequency pulse signal to the power converter upon receipt of a dimming signal of the dimming device, and the variable frequency pulse signal is used for controlling the operation of the power converter to achieve wide range dimming.

Preferably, the signal generator is a microprocessor, and the power converter is provided with a ground terminal.

Preferably, the power converter further includes a DC/DC controller, a metal oxide semiconductor (MOS) transistor and a voltage stabilizing filter element; one end of the DC/DC controller is connected to the microprocessor, and the other end of the DC/DC controller is connected to a gate of the MOS transistor; a source of the first MOS transistor is connected to the ground terminal, and a drain of the MOS transistor is connected to the voltage stabilizing filter element; the voltage stabilizing filter element includes a first diode, a first capacitor and an inductor; one end of the first capacitor is connected to the positive electrode end of an LED, and the other end of the first capacitor is connected to the negative electrode end of the LED.

Preferably, the frequency of the variable frequency pulse signal output by the microprocessor controls the DC/DC controller to keep the number of pulses during a high level time of the variable frequency pulse signal unchanged or varying within a small range.

Preferably, when the DC/DC controller is in a fixed frequency mode, the high level time of the variable frequency pulse signal output by the microprocessor is fixed, thereby controlling the number of the pulses to remain unchanged.

Preferably, when the DC/DC controller is in a variable frequency mode, the duration of the high level time of the variable frequency pulse signal output by the microprocessor is variable, thereby controlling the DC/DC controller to keep the number of output pulses during the high level time of the variable frequency pulse signal varying within a small range.

Preferably, the voltage stabilizing filter element further includes a first resistor, and the source of the MOS transistor is connected to the first resistor and then connected to the ground terminal.

As a preferred solution 1, the drain of the MOS transistor is connected in parallel to an anode of the first diode and one end of the inductor, the input voltage is connected in parallel to a cathode of the first diode and the end of the first capacitor, and the other end of the inductor is connected to the other end of the first capacitor.

As a preferred solution 2, the drain of the MOS transistor is connected in parallel to one end of the inductor and the anode of the first diode, and the other end of the inductor is connected to the input voltage; the cathode of the first diode is connected to the end of the first capacitor, and the other end of the first capacitor is further connected to the source of the MOS transistor.

As a preferred solution 3, the voltage stabilizing filter element further includes a transformer, a second diode, a second capacitor, and a second resistor, where the input voltage is connected in parallel to one end of the second capacitor, one end of the second resistor, and one end of a primary coil of the transformer; the other end of the second capacitor and the other end of the second resistor are connected in parallel to a cathode of the second diode; the drain of the MOS transistor is connected in parallel to the anode of the first diode and the other end of the primary coil of the transformer; one end of a secondary coil of the transformer is connected to the anode of the first diode, the cathode of the first diode is connected to the end of the first capacitor, and the other end of the secondary coil of the transformer is connected to the other end of the first capacitor.

The positive improvement effects of the present invention are as follows:

A signal generated by the present invention is formed by combining a variable frequency signal with a power conversion line. A wide dimming range is achieved, and a dimming depth can reach 1‰ of a rated current. An output ripple of the power converter is small, and the LED lamp is free of flicker during the dimming process and after the dimming is stable. An output ripple is small during the dimming, and the power converter can achieve higher conversion efficiency and output power using a lower switching frequency.

### BRIEF DESCRIPTION OF THE DRAWINGS

FIG. 1 is a schematic view of an overall structure according to a preferred embodiment of the present invention;

FIG. 2 is a schematic view of a structure according to a first preferred embodiment of the present invention;

FIG. 3 is a schematic view of a structure according to a second preferred embodiment of the present invention;

FIG. 4 is a schematic view of a structure according to a third preferred embodiment of the present invention;

FIG. 5 is a schematic view showing a comparison between a pulse width modulation dimming signal output by a microprocessor and a variable frequency pulse dimming signal output by the microprocessor according to a preferred embodiment of the present invention;

FIG. 6 is a schematic diagram showing a comparison between an output of a DC/DC controller during pulse width modulation (PWM) and an output of the DC/DC controller during pulse frequency modulation (PFM) of a variable frequency pulse signal according to a preferred embodiment of the present invention; and

FIG. 7 is a schematic diagram showing a comparison between an output of a current during pulse width modulation (PWM) and an output of a current during pulse frequency modulation (PFM) of a variable frequency pulse signal according to a preferred embodiment of the present invention.

### DETAILED DESCRIPTION OF EMBODIMENTS

The present invention is further described below by embodiments, but the present invention is not therefore limited within the scope of the embodiments.

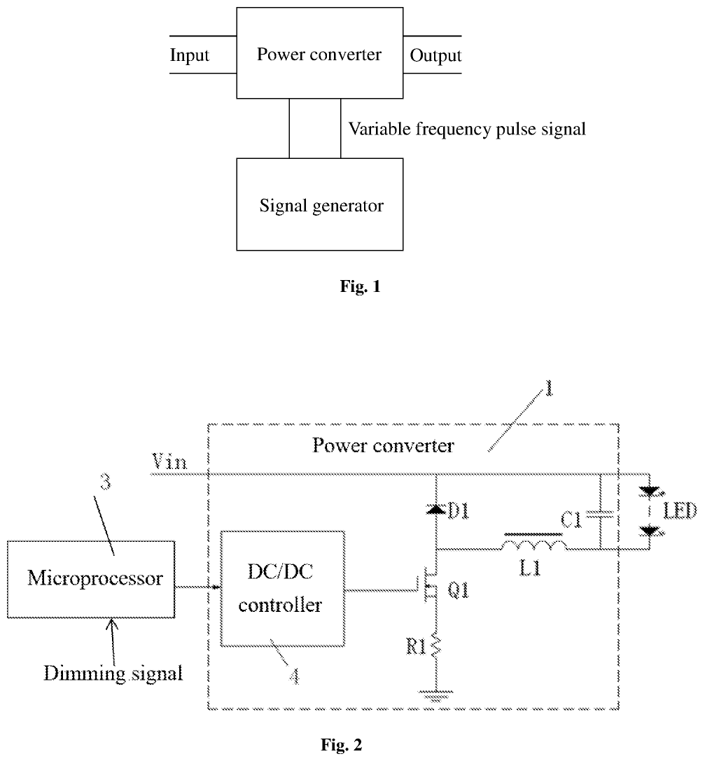

Referring to FIG. 1, a constant current dimming apparatus for an LED lamp according to the present invention includes a signal generator 2 and a power converter 1, where an input end of the signal generator 2 is externally connected to a dimming device; an output end of the signal generator 2 is connected to the power converter 1; an input end of the power converter 1 is connected to an input voltage; an output end of the power converter 1 is connected to a positive electrode end and a negative electrode end of the LED lamp; the signal generator 2 is used for transmitting a variable frequency pulse signal of pulse frequency modulation (PFM) to the power converter 1 upon receipt of a dimming signal of the dimming device, the variable frequency pulse signal PFM is used for controlling the operation of the power converter 1 to achieve wide range dimming, and the high level time of the PFM signal can be fixed or variable.

In the present invention, the signal generator 2 may be a microprocessor 3 or an analog device. The variable frequency signal can control a power conversion line separately, and can also, together with an analog voltage, control the power converter 1.

The high-level variable frequency signal of the present invention enables the power converter 1 to operate, and the power converter 1 is shut down when the signal is at a low level. The signal generator 2 has a built-in signal acquisition circuit, which converts the dimming signal into a digital quantity, and outputs a variable frequency dimming signal according to a mathematical model established by a program through a built-in timer or a PWM generator of the microprocessor 3. According to the present invention, a dimming depth of 1‰-100% is achieved, and the number of pulses output by a DC/DC controller 4 is stabilized during high level (enabling) time of the output variable frequency pulse dimming signal, wherein the fixed or variable enabling time may be adopted, and the brightness of the LED lamp is controlled by changing disabling time. Certainly, the present invention is not limited to this control form, and hybrid dimming can further be achieved in conjunction with PWM or analog dimming in actual use.

Based on the above technical conditions, the power converter 1 may further include a DC/DC controller 4, an MOS transistor Q1, and a voltage stabilizing filter element, and the power converter 1 may be provided with a ground terminal. The high level time of the variable frequency pulse signal of PFM can be fixed or variable, so that the number of pulses that are sent to the MOS transistor Q1 by the DC/DC controller 4 can remain unchanged during the dimming process, thereby achieving remove of constant light and variable light. Certainly, when the variable frequency pulse PFM signal changes slowly, the effect is better. The power converter 1 may further include, but is not limited to, boost, buck, Flyback, Buck-boost, LLC, LCC, and the like. One end of the DC/DC controller 4 is connected to the microprocessor 3, and the other end of the DC/DC controller 4 is connected to a gate of the MOS transistor Q1; a source of the MOS transistor Q1 is connected to the ground terminal, and a drain of the MOS transistor Q1 is connected to the voltage stabilizing filter element; the voltage stabilizing filter element includes a first diode D1, a first capacitor C1 and an inductor L1; one end of the first capacitor C1 is connected to the positive electrode end of an LED, and the other end of the first capacitor C1 is connected to the negative electrode end of the LED. The frequency of the variable frequency pulse PFM signal output by the microprocessor 3 controls the DC/DC controller 4 to keep the number of pulses during a high level time of the variable frequency pulse PFM signal unchanged or varying within a small range.

Preferably, when the DC/DC controller 4 is in a fixed frequency mode, the high level time of the variable frequency pulse PFM signal output by the microprocessor 3 is fixed, thereby controlling the number of the pulses to remain unchanged.

Preferably, when the DC/DC controller 4 is in a variable frequency mode, such as a boundary conduction mode (BCM) or an output current hysteretic control mode, the duration of the high level time of the variable frequency pulse PFM signal output by the microprocessor 3 is variable, thereby controlling the DC/DC controller 4 to keep the number of output pulses during the high level time of the variable frequency pulse signal varying within a small range.

The voltage stabilizing filter element may further include a first resistor R1, and the source of the MOS transistor Q1 is connected with the first resistor R1 and then connected with the ground terminal.

### Embodiment 1

Based on the above technology, as shown in FIG. 2, the voltage stabilizing filter element may further include an inductor L1. The drain of the MOS transistor Q1 is connected in parallel to an anode of the first diode D1 and one end of the inductor L1, the input voltage is connected in parallel to a cathode of the first diode D1 and the end of the first capacitor C1, and the other end of the inductor L1 is connected to the other end of the first capacitor C1.

### Embodiment 2

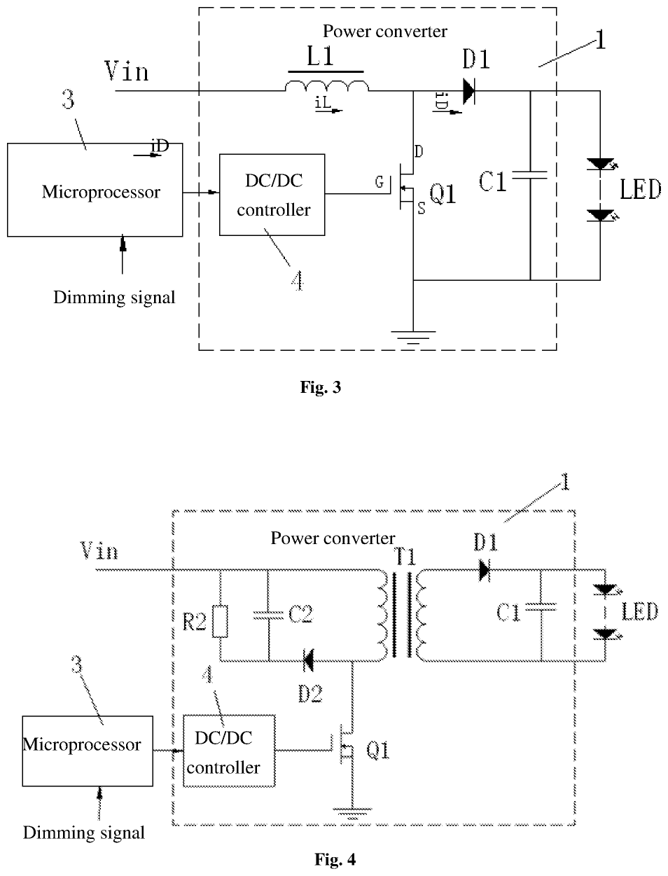

Based on the above technology, as shown in FIG. 3, the drain of the MOS transistor Q1 is connected in parallel to one end of the inductor L1 and the anode of the first diode D1, and the other end of the inductor L1 is connected to the input voltage; the cathode of the first diode D1 is connected to the end of the first capacitor C1, and the other end of the first capacitor C1 is further connected to the source of the MOS transistor Q1.

### Embodiment 3

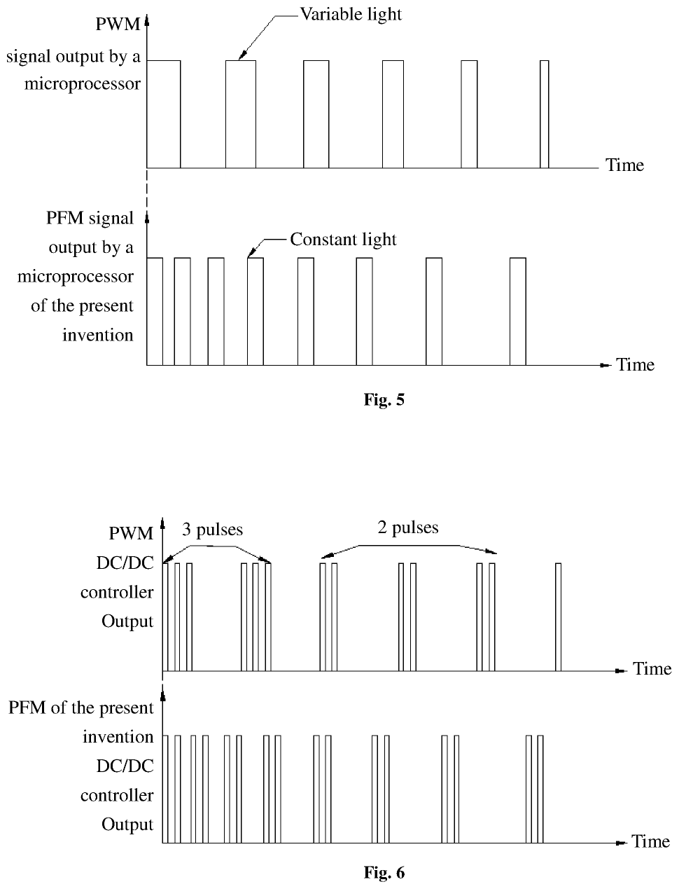

Based on the above technology, as shown in FIG. 4, the voltage stabilizing filter element further includes a transformer T1, a second diode D2, a second capacitor C2, and a second resistor R2, where the input voltage is connected in parallel to one end of the second capacitor C2, one end of the second resistor R2, and one end of a primary coil of the transformer T1; the other end of the second capacitor C2 and the other end of the second resistor R2 are connected in parallel to a cathode of the second diode D2; the drain of the MOS transistor Q1 is connected in parallel to the anode of the first diode D1 and the other end of the primary coil of the transformer T1; one end of a secondary coil of the transformer T1 is connected to the anode of the first diode D1, the cathode of the first diode D1 is connected to the end of the first capacitor C1, and the other end of the secondary coil of the transformer T1 is connected to the other end of the first capacitor C1.

Referring to a schematic view showing a comparison between a pulse width modulation dimming signal output by a microprocessor 3 and a variable frequency pulse dimming signal output by the microprocessor 3 in FIG. 5, the upper portion of the view shows a pulse width modulation (PWM) dimming signal output from the microprocessor 3, where during the high level time, the DC/DC controller is enabled, and during the low level time, the DC/DC controller is disabled. The lower portion of the view shows a variable frequency pulse PFM dimming signal output from the microprocessor 3 of the present invention, where the high level time is fixed. As can be seen from FIG. 5, the frequency of the pulse width modulation (PWM) is fixed, and the high level time varies. Therefore, the key to allowing the high level time of the PFM signal of the present invention to be fixed or change slowly lies in the capability of stabilizing the number of pulses output from the DC/DC controller 4, which can remove constant light and variable light.

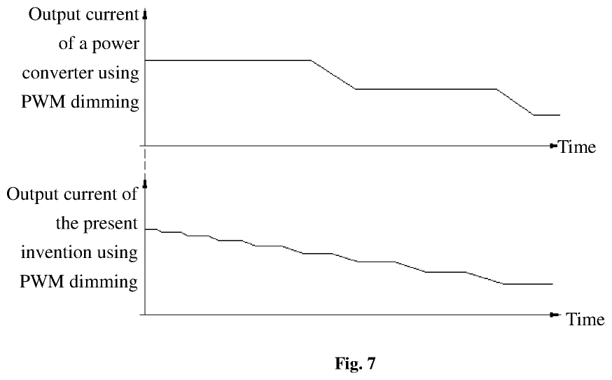

Referring to a schematic view showing a comparison between an output of the DC/DC controller 4 during the pulse width modulation (PWM) and an output of the DC/DC controller 4 during the PFM of the variable frequency pulse signal in FIG. 6, the upper portion of the view shows the output of the DC/DC controller 4 during the pulse width modulation (PWM), there are sometimes 3 pulses in succession, sometimes 2 pulses in succession, and sometimes 1 pulse; the lower portion of the view shows the output of the DC/DC controller 4 during the PFM of the variable frequency pulse signal in the present invention, where the output is continuously constant at 2 pulses. Referring to a schematic view showing a comparison between a current output during the pulse width modulation (PWM) and a current output during the PFM of the variable frequency pulse signal in FIG. 7. The upper portion of the view shows the current output during the pulse width modulation (PWM), where waveform fluctuations are large; the lower portion of the view shows the current output during the PFM of the present invention, where it can be seen that the waveform changes gently.

Therefore, the output signal of the present invention is smoother and more uniform than a PWM signal output by a microprocessor in the prior art. A wide dimming range is achieved, and a dimming depth can reach 1‰ of a rated current. The LED lamp is free of flicker during the dimming process and after the dimming is stable, and the DC/DC controller can achieve higher conversion efficiency and output power using a lower switching frequency.

According to requirements for different applications, in the present invention, dimming can also be performed by combining a simulator and the PFM of the variable frequency pulse signal, or by combining the pulse width modulation (PWM) with the PFM of the variable frequency pulse signal, or by combination of the simulator, the pulse width modulation (PWM) and the PFM of the variable frequency pulse signal. These applications are in the protection scope of the present invention.

The present invention has been described above in detail with reference to the embodiments of the accompanying drawings, and variations of the embodiments of the present invention can be made by those of ordinary skill in the art in light of the above description. Any modification, equivalent substitution, improvement, and the like, within the spirit and scope of the present invention shall fall into the protection scope of the present invention. Therefore, some details in the embodiments should not be construed as a limitation on the present invention, and the protection scope of the present invention is subject to the scope defined by the appended claims.

1. A constant current dimming apparatus for an LED lamp, comprising a signal generator and a power converter, wherein an input end of the signal generator is externally connected to a dimming device; an output end of the signal generator is connected to the power converter; an input end of the power converter is connected to an input voltage; an output end of the power converter is connected to a positive electrode end and a negative electrode end of the LED lamp; the signal generator is used for transmitting a variable frequency pulse signal to the power converter upon receipt of a dimming signal of the dimming device, and the variable frequency pulse signal is used for controlling the operation of the power converter to achieve wide range dimming.

2. The constant current dimming apparatus for an LED lamp according to claim 1, wherein the signal generator is a microprocessor, and the power converter is provided with a ground terminal.

3. The constant current dimming apparatus for an LED lamp according to claim 2, wherein the power converter further comprises a DC/DC controller, a metal oxide semiconductor (MOS) transistor and a voltage stabilizing filter element; one end of the DC/DC controller is connected to the microprocessor, and the other end of the DC/DC controller is connected to a gate of the MOS transistor; a source of the MOS transistor is connected to the ground terminal, and a drain of the MOS transistor is connected to the voltage stabilizing filter element; the voltage stabilizing filter element comprises a first diode, a first capacitor and an inductor; one end of the first capacitor is connected to the positive electrode end of an LED, and the other end of the first capacitor is connected to the negative electrode end of the LED.

4. The constant current dimming apparatus for an LED lamp according to claim 3, wherein the frequency of the variable frequency pulse signal output by the microprocessor controls the DC/DC controller to keep the number of pulses during a high level time of the variable frequency pulse signal unchanged or varying within a small range.

5. The constant current dimming apparatus for an LED lamp according to claim 4, wherein when the DC/DC controller is in a fixed frequency mode, the high level time of the variable frequency pulse signal output by the microprocessor is fixed, thereby controlling the number of the pulses to remain unchanged.

6. The constant current dimming apparatus for an LED lamp according to claim 4, wherein when the DC/DC controller is in a variable frequency mode, the duration of the high level time of the variable frequency pulse signal output by the microprocessor is variable, thereby controlling the DC/DC controller to keep the number of output pulses during the high level time of the variable frequency pulse signal varying within a small range.

7. The constant current dimming apparatus for an LED lamp according to claim 3, wherein the voltage stabilizing filter element further comprises a first resistor, and the source of the MOS transistor is connected to the first resistor and then connected to the ground terminal.

8. The constant current dimming apparatus for an LED lamp according to claim 7, wherein the drain of the MOS transistor is connected in parallel to an anode of the first diode and one end of the inductor, the input voltage is connected in parallel to a cathode of the first diode and the end of the first capacitor, and the other end of the inductor is connected to the other end of the first capacitor.

9. The constant current dimming apparatus for an LED lamp according to claim 3, wherein the drain of the MOS transistor is connected in parallel to one end of the inductor and the anode of the first diode, and the other end of the inductor is connected to the input voltage; the cathode of the first diode is connected to the end of the first capacitor, and the other end of the first capacitor is further connected to the source of the MOS transistor.

10. The constant current dimming apparatus for an LED lamp according to claim 3, wherein the voltage stabilizing filter element further comprises a transformer, a second diode, a second capacitor, and a second resistor, wherein the input voltage is connected in parallel to one end of the second capacitor, one end of the second resistor, and one end of a primary coil of the transformer; the other end of the second capacitor and the other end of the second resistor are connected in parallel to a cathode of the second diode; the drain of the MOS transistor is connected in parallel to the anode of the first diode and the other end of the primary coil of the transformer; one end of a secondary coil of the transformer is connected to the anode of the first diode, the cathode of the first diode is connected to the end of the first capacitor, and the other end of the secondary coil of the transformer is connected to the other end of the first capacitor.
